(19) United States
(12) Patent Application Publication
(10) Pub. No.: US 2009/0278486 A1
(43) Pub. Date: Nov. 12, 2009

(54) Motor Controlling Method for Rotating a Lift Arm of an Adjustable Bed according to a Predetermined Bending Angle of the Lift Arm

(76) Inventors: Chun-Sheng Lin, Taipei (TW); Cameron Grant Noles, Elk Grove, CA (US); Joseph Michael Piana, Cleveland, TN (US)

Correspondence Address: NORTH AMERICA INTELLECTUAL PROPERTY CORPORATION, P.O. BOX 506, MERRIFIELD, VA, 22116, US

(21) Appl. No.: 12/115,554

(22) Filed: May 6, 2008

(51) Int. Cl. H02K 29/10

(52) U.S. Cl. 318/466

(57) ABSTRACT

In an adjustable bed, a bending angle of a lift arm is precisely adjusted according to generated signals corresponding to a wheel rotated by a motor of the adjustable bed or according to a current state related to the wheel. The signals are generated according to whether light is obstructed by gratings, according to whether a magnetic force is detected, or according to a change of a magnetic field. The current state is current resistance of a variable resistor disposed near the wheel.

### BACKGROUND OF THE INVENTION

1. Field of the Invention

The present invention relates to a motor controlling method for rotating a lift arm of an adjustable bed, and more particularly, to a motor controlling method for rotating a lift arm of an adjustable bed according to a predetermined bending angle of the lift arm.

2. Description of the Prior Art

A conventional adjustable bed includes a ground-engaging stationary frame and a lift arm. A bending angle of the lift arm between the stationary frame and the lift arm is adjustable so that a user of the conventional adjustable bed is able to make himself comfortable on the adjustable bed by choosing a preferred bending angle of the lift arm. A wheel of the motor is connected to or coupled to the lift arm so as to apply a force generated by the motor to the lift arm. The size of the bending angle is controlled according to the number of rotations of the wheel, i.e., the number of rotations of the motor. That is, the size of the bending angle is proportional to the number of rotations of the motor.

For certain conventional adjustable bed, the length of time for driving the motor is controlled to tune the bending angle of the lift arm to a finest degree. For example, when the motor is driven for 1 second, the bending angle is changed by 30 degrees; and when the motor is driven for 2 seconds, the bending angle is changed by 60 degrees. However, controlling the time length for driving the motor may not accurately control the magnitude of the bending angle since the lift arm may not be stopped as soon as the motor is stopped, and acceleration of the motor also takes some time, and this time is not taken into considerations in the time-controlling technique.

### SUMMARY OF THE INVENTION

The claimed invention discloses a motor controlling method for rotating a lift arm of an adjustable bed according to a predetermined bending angle of the lift arm. The motor controlling method comprises determining a number of rotations that a wheel is to be rotated by a motor according to the predetermined bending angle of the lift arm of the adjustable bed, calculating an expected number of signals according to the number of rotations; and driving the motor to rotate the wheel and generating a signal whenever light is obstructed by one of a plurality of optical gratings while the wheel is rotated by the motor until a number of generated signals reaches the expected number.

The claimed invention further discloses a motor controlling method for rotating a lift arm of an adjustable bed according to a predetermined bending angle of the lift arm. The motor controlling method comprises determining a number of rotations that a wheel is to be rotated by a motor according to the predetermined bending angle of the lift arm of the adjustable bed, calculating an expected number of signals according to the number of rotations, and driving the motor to rotate the wheel and generating a signal whenever a magnetic force of a magnet on the wheel is detected by a magnetic force sensor while the wheel is rotated by the motor until a number of generated signals reaches the expected number.

The claimed invention further discloses a motor controlling method for rotating a lift arm of an adjustable bed according to a predetermined bending angle of the lift arm. The motor controlling method comprises determining a number of rotations that a wheel is to be rotated by a motor according to the predetermined bending angle of the lift arm of the adjustable bed, calculating an expected resistance of a variable resistor coupled to the wheel according to the number of rotations, and driving the motor to rotate the wheel and measuring a current resistance of the variable resistor while the wheel is rotated by the motor until the current resistance of the variable resistor reaches the expected resistance.

The claimed invention further discloses a motor controlling method for rotating a lift arm of an adjustable bed according to a predetermined bending angle of the lift arm. The motor controlling method comprises determining a number of rotations that a wheel is to be rotated by a motor according to the predetermined bending angle of the lift arm of the adjustable bed, calculating an expected number of signals according to the number of rotations, and driving the motor to rotate the wheel and generating a signal whenever a magnetic field generated by a plurality of permanent magnets on the wheel is changed while the wheel is rotated by the motor until a number of generated signals reaches the expected number.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a flowchart of a motor controlling method of the present invention for controlling a bending angle of an adjustable bed by using optical gratings.

FIG. 2 is a simplified blow chart for explaining the motor controlling method described in FIG. 1.

FIG. 3 is a flowchart of a motor controlling method of the present invention for controlling a bending angle of an adjustable bed by using magnets.

FIG. 4 is a simplified blow chart for explaining the motor controlling method described in FIG. 3.

FIG. 5 is a flowchart of a motor controlling method of the present invention for controlling a bending angle of an adjustable bed by using a variable resistor.

FIG. 6 is a simplified diagram for explaining the motor controlling method described in FIG. 5.

FIG. 7 is a flowchart of a motor controlling method of the present invention for controlling a bending angle of an adjustable bed by taking advantages of the Hall Effect.

FIG. 8 is a simplified blow chart for explaining the motor controlling method described in FIG. 7.

FIG. 9 illustrates a schematic top view of an adjustable bed using one of the disclosed motor controlling methods of the present invention.

FIG. 10 illustrates an exemplary diagram of the controller shown in FIG. 9.

### DETAILED DESCRIPTION

For precisely controlling a bending angle of an adjustable bed, the present invention discloses some motor controlling methods for rotating a lift arm of an adjustable bed according to a predetermined bending angle of the lift arm. Note that the predetermined bending angle of the lift arm may be inputted by a user of the adjustable bed. With the aid of the motor controlling methods of the present invention, the lift arm may be rotated more precisely in the predetermined bending angle than the lift arm of the conventional adjustable bed using the time-controlling technique in the prior art.

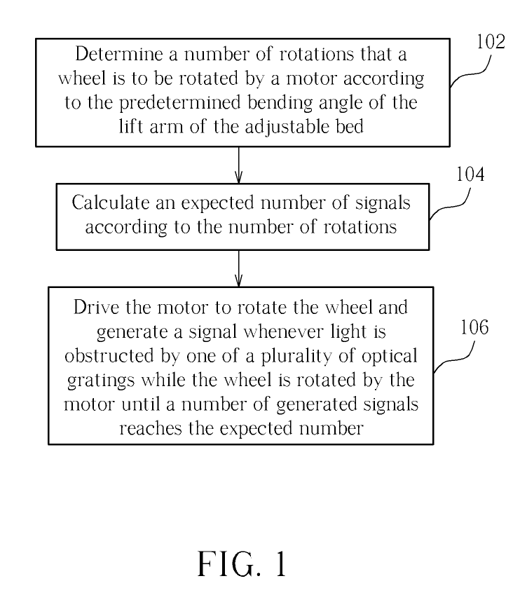

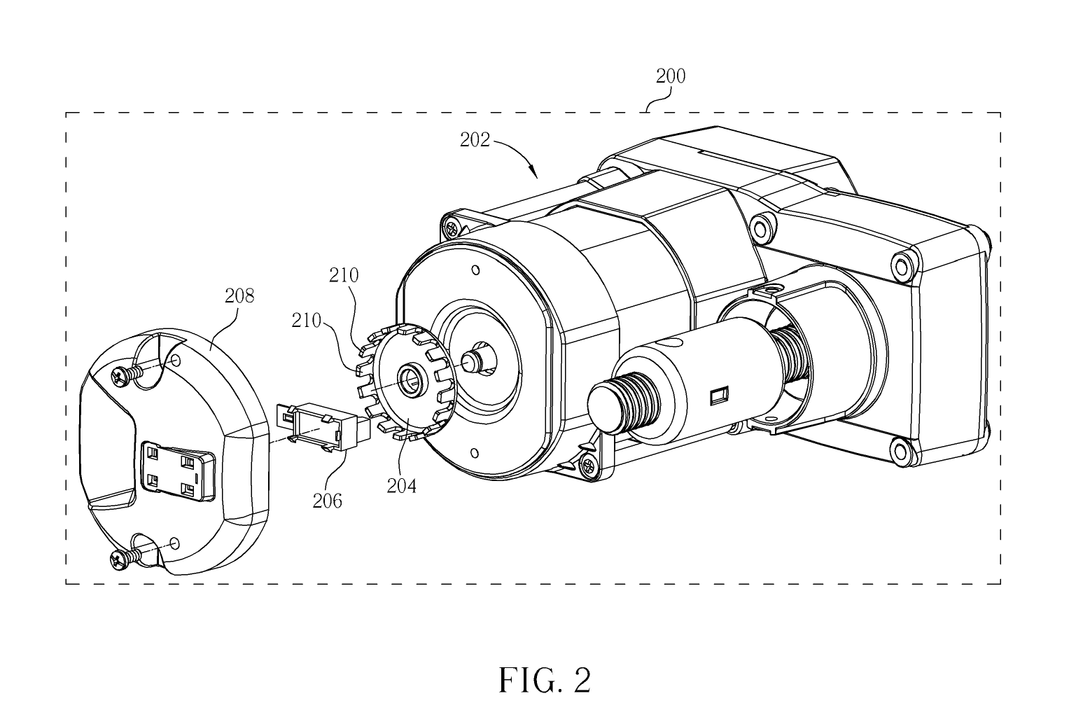

Please refer to FIG. 1 and FIG. 2. FIG. 1 is a flowchart of a motor controlling method of the present invention for controlling a bending angle of an adjustable bed by using optical gratings. FIG. 2 is a simplified flowchart for explaining the motor controlling method described in FIG. 1. As shown in FIG. 1, the motor controlling method by using optical gratings includes steps as follows:

Step 102: Determine a number of rotations that a wheel is to be rotated by a motor according to the predetermined bending angle of the lift arm of the adjustable bed;

Step 104: Calculate an expected number of signals according to the number of rotations; and

Step 106: Drive the motor to rotate the wheel and generate a signal whenever light is obstructed by one of a plurality of optical gratings while the wheel is rotated by the motor until a number of generated signals reaches the expected number.

In FIG. 2, a motor 200 used in an adjustable bed using the motor controlling method shown in FIG. 1 is illustrated. Note that the motor 200 is used for rotating a lift arm with respect to a stationary frame of the adjustable bed. The motor 200 includes a body 202, a wheel 204 connected to the body 202 and driven by the motor 200, a light sensor 206 disposed near the wheel 204, and a housing 208 for shielding the wheel 204 and the light sensor 206. A plurality of optical gratings 210 is disposed around and on the wheel 204. While the wheel 204 is rotated by the motor 200, light is obstructed by the optical gratings 210. Each time when light obstructed by one of the optical gratings 210 is detected by the light sensor 206, a corresponding signal is generated. A primary aim of the present invention lies in the fact that each time when a user of the adjustable bed inputs a predetermined bending angle of the lift arm, the motor 200 is able to rotate the wheel with an expected number of rotations (or turns) corresponding to the predetermined bending angle. Therefore, when the user inputs the predetermined bending angle, a corresponding number of rotations that the wheel 204 is to be rotated by the motor 200 is determined, and an expected number of the generated signals from the light sensor 206 is calculated corresponding to the calculated number of rotations in Step 108. At this time, a relationship between the predetermined bending angle of the lift arm and the number of generated signals is established. Then the motor 200 is driven until the expected number of generated signals from the light sensor 206 is accumulated and reached; at this time, the predetermined bending angle inputted by the user is precisely reached as well.

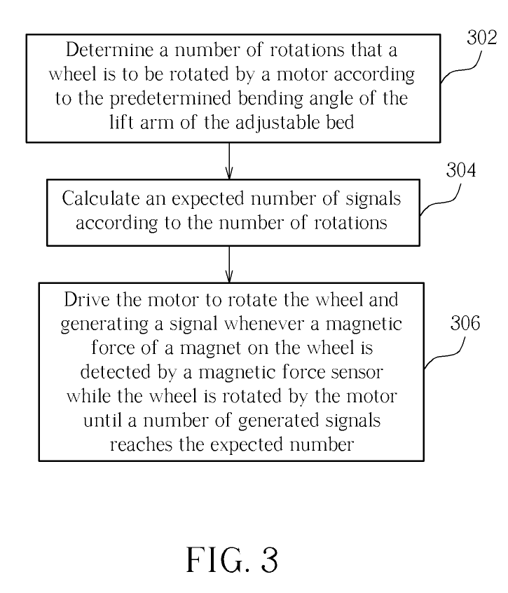

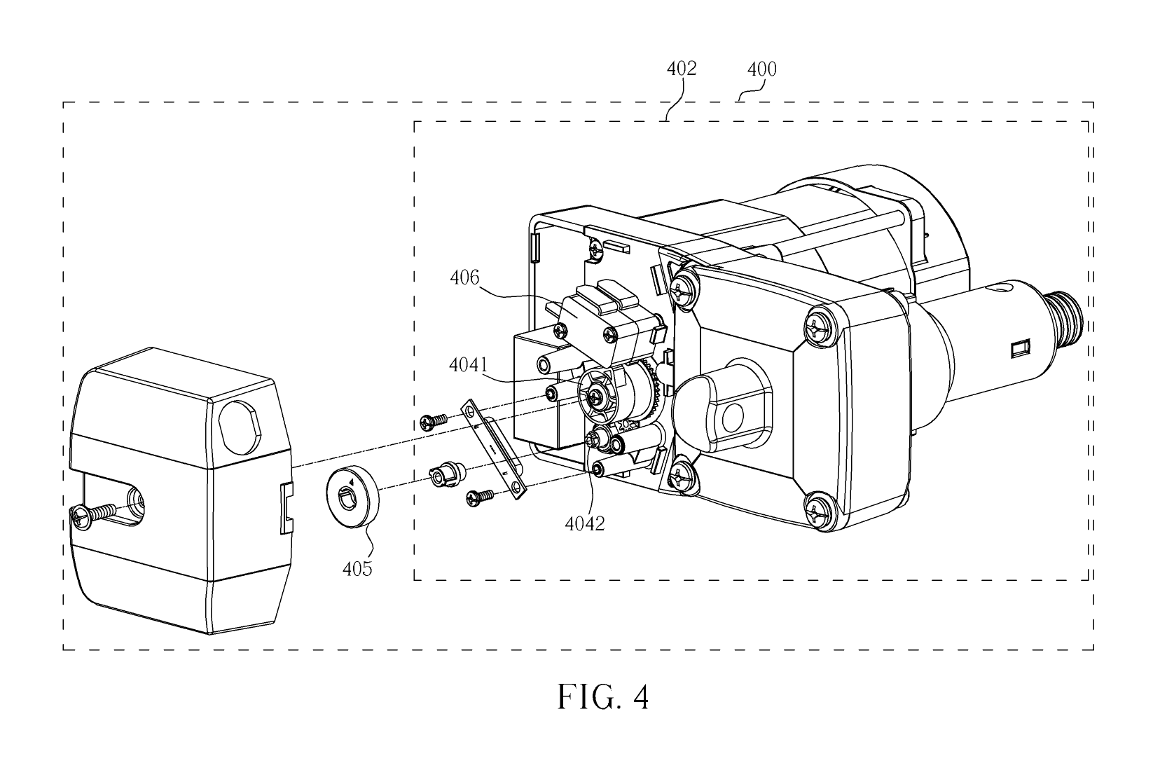

Please refer to FIG. 3 and FIG. 4. FIG. 3 is a flowchart of a motor controlling method of the present invention for controlling a bending angle of an adjustable bed by using magnets. FIG. 4 is a simplified blow chart for explaining the motor controlling method described in FIG. 3. As shown in FIG. 3, the motor controlling method by using magnets includes steps as follows:

Step 302: Determine a number of rotations that a wheel is to be rotated by a motor according to the predetermined bending angle of the lift arm of the adjustable bed;

Step 304: Calculate an expected number of signals according to the number of rotations; and

Step 306: Drive the motor to rotate the wheel and generating a signal whenever a magnetic force of a magnet on the wheel is detected by a magnetic force sensor while the wheel is rotated by the motor until a number of generated signals reaches the expected number.

In FIG. 4, a motor 400 used in an adjustable bed using the motor controlling method shown in FIG. 3 is illustrated. Note that the motor 400 is used for rotating a lift arm with respect to a stationary frame of the adjustable bed. The motor 400 includes a body 402, two driving wheels 4041 and 4042 connected to the body 402 and driven by the motor 400, a wheel 405 connected to the driving wheel 4042 and indirectly rotated by the motor 400 through the driving wheel 4042, a magnetic force sensor 406 disposed near the body 402, and a housing 408 for shielding the body 402. At least one magnet is hidden inside the wheel 405. While the wheel 405 is rotated by the motor 400, and each time when one magnet hidden within the wheel 405 is moved within a detecting range of the magnetic force sensor 406, a magnetic force generated from the hidden magnet is detected by the magnetic force sensor 406 so that a corresponding signal is generated from the magnetic force sensor 406. According to the primary aim of the present invention discussed above, when the user inputs the predetermined bending angle, a corresponding number of rotations that the wheel 405 is to be rotated by the motor 400 is calculated, and an expected number of the generated signals from the magnetic force sensor 406 is calculated corresponding to the calculated number of rotations. At this time, a relationship between the predetermined bending angle of the lift arm and the number of generated signals is established. Then the motor 400 is driven until the expected number of generated signals from the magnetic force sensor 406 is accumulated and reached; thus the predetermined bending angle inputted by the user is precisely reached as well.

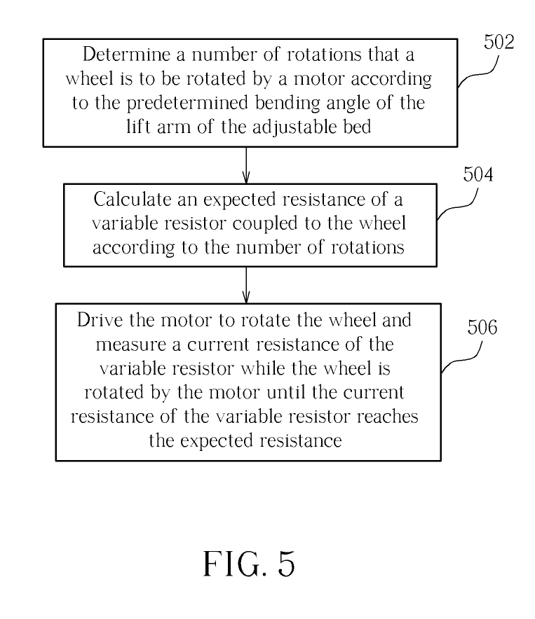

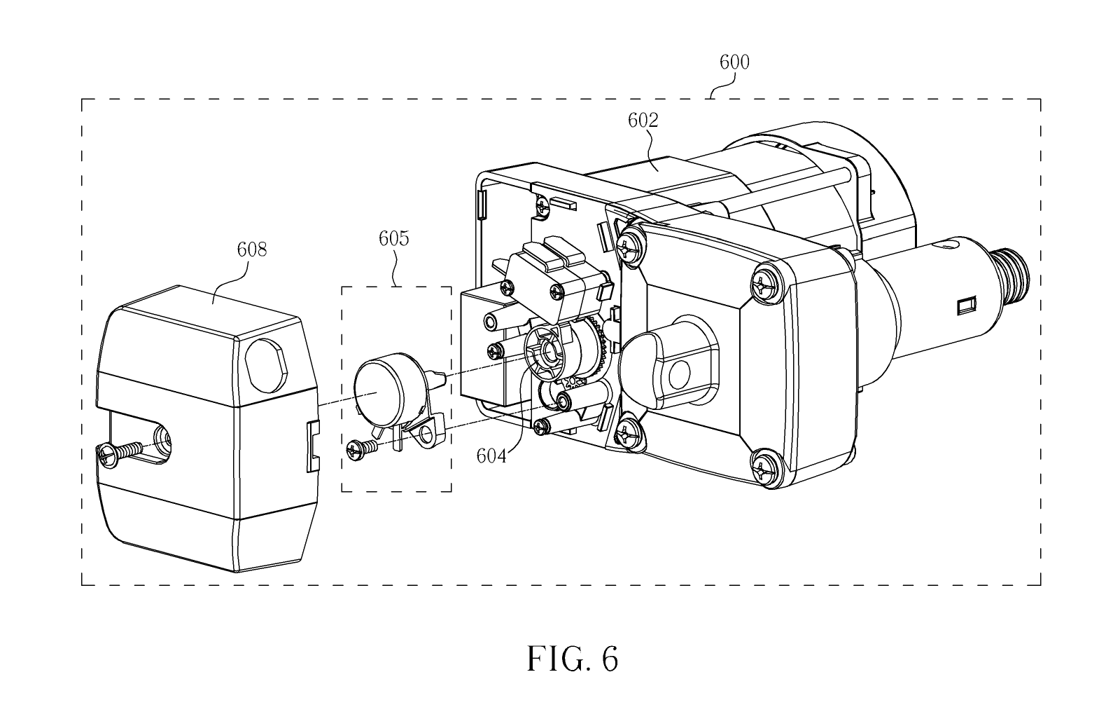

Please refer to FIG. 5 and FIG. 6. FIG. 5 is a flowchart of a motor controlling method of the present invention for controlling a bending angle of an adjustable bed by using a variable resistor. FIG. 6 is a simplified diagram for explaining the motor controlling method described in FIG. 5. As shown in FIG. 5, the motor controlling method by using a variable resistor includes steps as follows:

Step 502: Determine a number of rotations that a wheel is to be rotated by a motor according to the predetermined bending angle of the lift arm of the adjustable bed;

Step 504: Calculate an expected resistance of a variable resistor coupled to the wheel according to the number of rotations; and

Step 506: Drive the motor to rotate the wheel and measure a current resistance of the variable resistor while the wheel is rotated by the motor until the current resistance of the variable resistor reaches the expected resistance.

In FIG. 6, a motor 600 used in an adjustable bed using the motor controlling method shown in FIG. 5 is illustrated. Note that the motor 600 is used for rotating a lift arm of the adjustable bed with respect to the stationary frame. The motor 600 includes a body 602, a wheel 604 connected to the body 602 and driven by the motor 600, a variable resistor 605 connected to the wheel 604 and driven by the motor 600, and a housing 608 for shielding the body 602. Note that resistance of the variable resistor 605 corresponds to different bending angles of the lift arm respect to the stationary frame so that a magnitude of the bending angle may be instantly derived according to current resistance of the variable resistor with the aid of simple calculations. While the wheel 604 is rotated by the motor 600, resistance of the variable resistor 605 varies as well. According to the primary aim of the present invention discussed above, when the user inputs the predetermined bending angle, expected resistance corresponding to the inputted bending angle is instantly calculated. Then, the motor 600 is driven to rotate the wheel, and current resistance of the variable resistor 605 is measured, until the measured current resistance of the variable resistor 605 reaches the expected resistance; at this time, the predetermined bending angle inputted by the user is precisely reached as well.

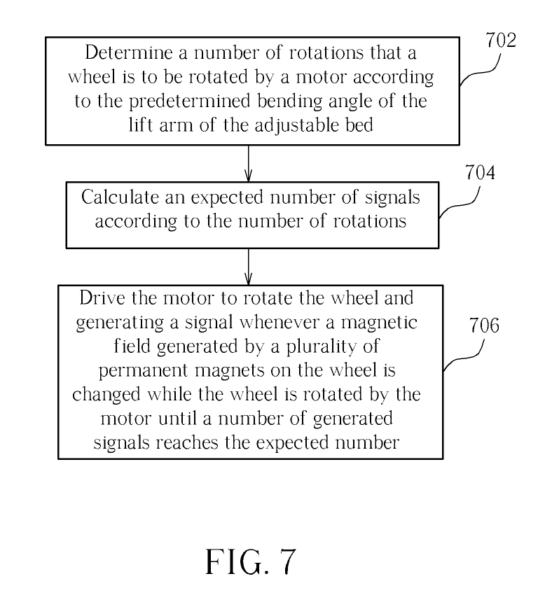

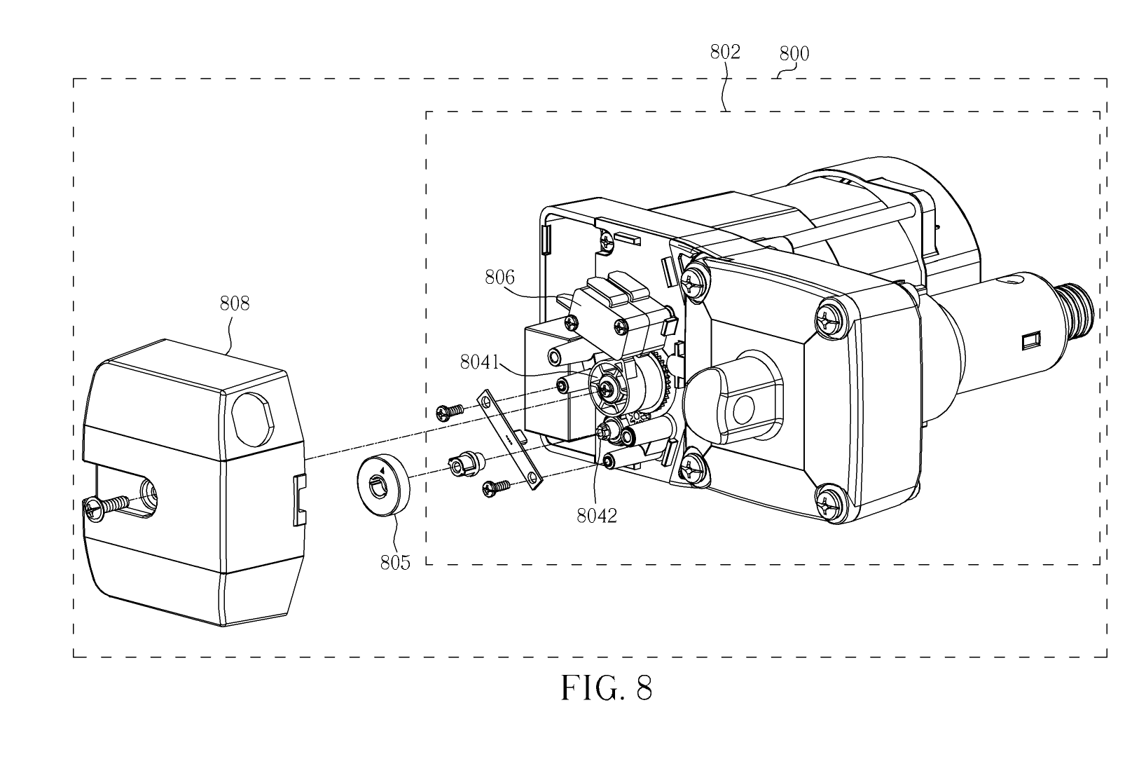

Please refer to FIG. 7 and FIG. 8. FIG. 7 is a flowchart of a motor controlling method of the present invention for controlling a bending angle of an adjustable bed by taking advantages of the Hall Effect. FIG. 8 is a simplified blow chart for explaining the motor controlling method described in FIG. 7. As shown in FIG. 7, the motor controlling method by taking advantages of the Hall Effect includes steps as follows:

Step 702: Determine a number of rotations that a wheel is to be rotated by a motor according to the predetermined bending angle of the lift arm of the adjustable bed;

Step 704: Calculate an expected number of signals according to the number of rotations; and

Step 706: Drive the motor to rotate the wheel and generating a signal whenever a magnetic field generated by a plurality of permanent magnets on the wheel is changed while the wheel is rotated by the motor until a number of generated signals reaches the expected number.

In FIG. 8, a motor 800 used in an adjustable bed using the motor controlling method shown in FIG. 7 is illustrated. The motor 800 includes a body 802, driving wheels 8041 and 8042 connected to the body 802 and driven by the motor 800, a wheel 805 connected to the driving wheel 8042 and indirectly rotated by the motor 800 through the driving wheel 8042, a Hall sensor 806 disposed near the body 802, and a housing 808 for shielding the body 802. Note that the motor 800 is used for rotating a lift arm with respect to a stationary frame of the adjustable bed. At least one permanent magnet is disposed around the wheel 805. With respect to the Hall Effect, each time when the permanent magnets are rotated along with the wheel 805 rotated by the motor 800, a magnetic field generated from the permanent magnets is changed in magnitude and direction, and a corresponding voltage (i.e., the Hall voltage) or a current corresponding to the Hall voltage for resisting the change of the magnetic field is thereby generated inside the Hall sensor 806. Note that the generated voltage or current may be represented in a form of a generated signal, i.e., each time when the generated magnetic field is changed by a predetermined amount, a corresponding signal may be issued from the Hall sensor 806, which may be implemented as a Hall switch at this time in a preferred embodiment of the present invention. According to the primary aim of the present invention discussed above, when the user inputs the predetermined bending angle, a corresponding number of rotations that the wheel 805 is to be rotated by the motor 800 is determined, and an expected number of the generated signals from the Hall sensor 806 is calculated corresponding to the calculated number of rotations. At this time, a relationship between the predetermined bending angle of the lift arm and the number of generated signals is established. Then the motor 800 is driven until the expected number of generated signals from the Hall sensor 806 is accumulated and reached; at this time, the predetermined bending angle inputted by the user is precisely reached as well.

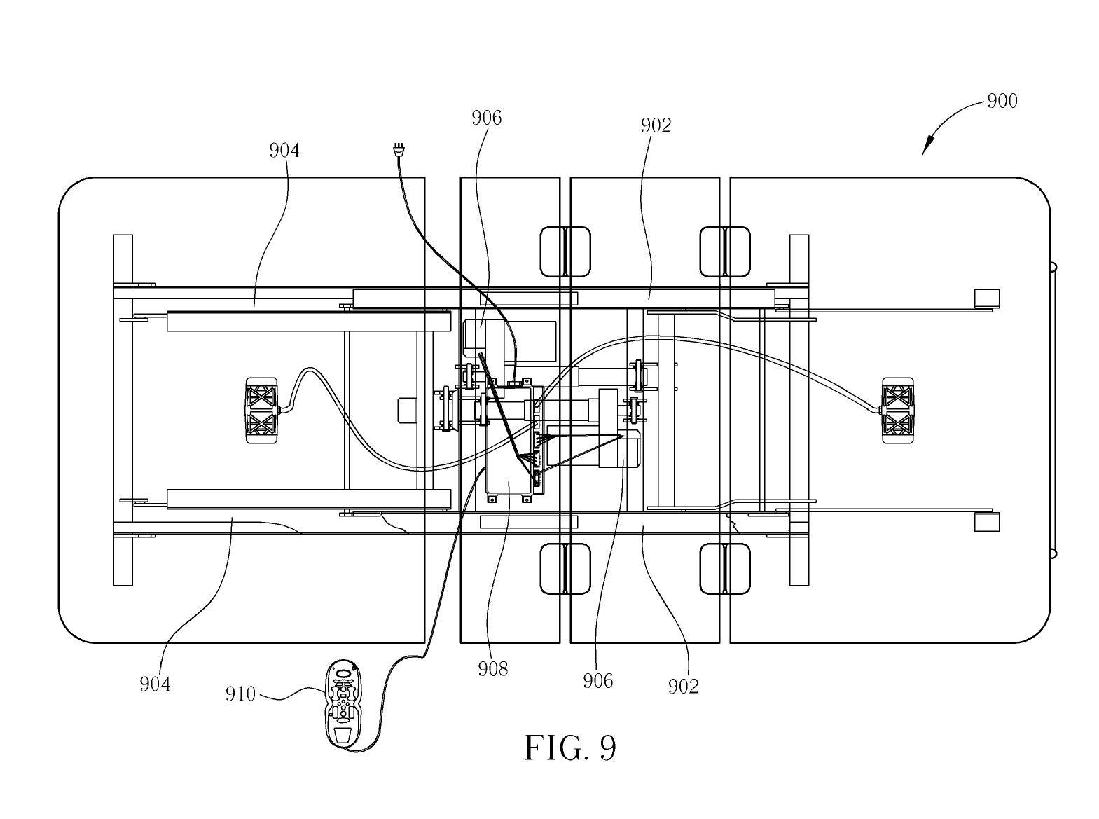

Please refer to FIG. 9, which illustrates a schematic top view of an adjustable bed using one of the disclosed motor controlling methods of the present invention. In FIG. 9, an adjustable bed 900 primarily includes two stationary frames 902, two lift arms 904 respectively coupled to the stationary frames 902, two motors 906 coupled to the lift arms 904 for respectively lifting the lift arms 904 with respect to both the stationary frames 902, a command issuer 908 for controlling both the motors 906, and a controller 910 for inputting a predetermined bending angle of both the lift arms 904 into the command issuer 908. Note that the command issuer 908 controls both the motors 906 according to the inputted bending angle from the controller 910. The abovementioned motor controlling methods are primarily implemented in the command issuer 908. Therefore, the command issuer 908 receives information from sensors disposed with the motors 906 and controls the motors 906 to rotate the lift arms 904 to the bending angle inputted from the controller 910. A user of the adjustable bed 900 may give the bending angle through the controller 910 according to his or her instant requirements. Other elements of the adjustable bed 900 are the same with those in conventional adjustable beds so that the other un-discussed elements are not described further for brevity.

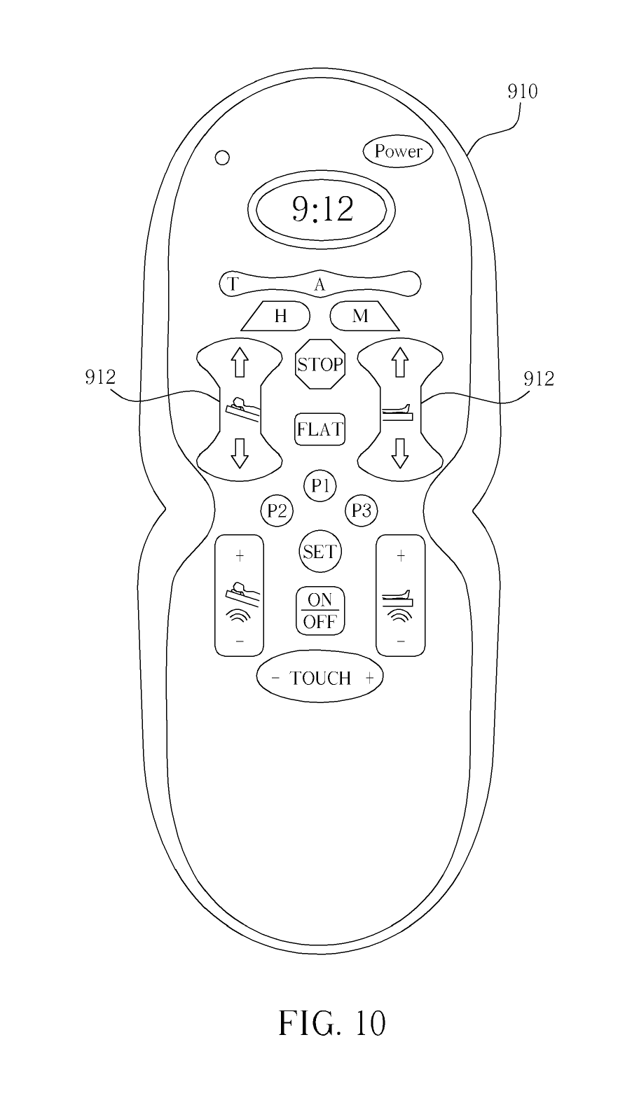

Please refer to FIG. 10, which illustrates an exemplary diagram of the controller 910 shown in FIG. 9. As shown in FIG. 10, some angle buttons 912 are disposed on the controller 910, where P1, P2, and P3 indicate different bending angles of the lift arms 904. For example, when the user presses the P1 button, the lift arms 904 are lifted by the motors 906 to a bending angle corresponding to the button P1. Some directional buttons 914 are also disposed on the controller 910. For example, when an upward button of the directional buttons is pressed by the user, the lift arms 904 are kept on being lifted until the user releases the upward button or until the lift arms 904 reach their structural limitations.

The present invention discloses some motor controlling methods for rotating a lift arm of an adjustable bed according to a predetermined bending angle of the lift arm. With the aid of the disclosed motor controlling methods, the bending angle of the lift arm may be more precisely adjusted than adjustable beds of the prior art.

Those skilled in the art will readily observe that numerous modifications and alterations of the device and method may be made while retaining the teachings of the invention.

What is claimed is:

1. A motor controlling method for rotating a lift arm of an adjustable bed according to a predetermined bending angle of the lift arm, comprising:
determining a number of rotations that a wheel is to be rotated by a motor according to the predetermined bending angle of the lift arm of the adjustable bed;
calculating an expected number of signals according to the number of rotations; and
driving the motor to rotate the wheel and generating a signal whenever light is obstructed by one of a plurality of optical gratings while the wheel is rotated by the motor until a number of generated signals reaches the expected number.

2. A motor controlling method for rotating a lift arm of an adjustable bed according to a predetermined bending angle of the lift arm, comprising:
determining a number of rotations that a wheel is to be rotated by a motor according to the predetermined bending angle of the lift arm of the adjustable bed;
calculating an expected number of signals according to the number of rotations; and
driving the motor to rotate the wheel and generating a signal whenever a magnetic force of a magnet on the wheel is detected by a magnetic force sensor while the wheel is rotated by the motor until a number of generated signals reaches the expected number.

3. A motor controlling method for rotating a lift arm of an adjustable bed according to a predetermined bending angle of the lift arm, comprising:
determining a number of rotations that a wheel is to be rotated by a motor according to the predetermined bending angle of the lift arm of the adjustable bed;
calculating an expected resistance of a variable resistor coupled to the wheel according to the number of rotations; and
driving the motor to rotate the wheel and measuring a current resistance of the variable resistor while the wheel is rotated by the motor until the current resistance of the variable resistor reaches the expected resistance.

4. A motor controlling method for rotating a lift arm of an adjustable bed according to a predetermined bending angle of the lift arm, comprising:
determining a number of rotations that a wheel is to be rotated by a motor according to the predetermined bending angle of the lift arm of the adjustable bed;
calculating an expected number of signals according to the number of rotations; and
driving the motor to rotate the wheel and generating a signal whenever a magnetic field generated by a plurality of permanent magnets on the wheel is changed while the wheel is rotated by the motor until a number of generated signals reaches the expected number.
